(19) United States
(12) Patent Application Publication
(10) Pub. No.: US 2008/0181392 A1
(43) Pub. Date: Jul. 31, 2008

(54) Echo cancellation and noise suppression calibration in telephony devices

(76) Inventor: Mohammad Reza Zad-Issa, Irvine, CA (US)

Correspondence Address: BRAKE HUGHES BELLERMANN LLP;c/o Intellevate, P.O. Box 52050, Minneapolis, MN, 55402, US

(21) Appl. No.: 11/700,527

(22) Filed: Jan. 31, 2007

(51) Int. Cl. H04M 9/08

(52) U.S. Cl. 379/406.08

(57) ABSTRACT

Methods and apparatus for noise suppression and echo cancellation are disclosed. An example embodiment of a method for noise suppression and echo cancellation includes monitoring an audio channel in a telephony device and determining, as a result of the monitoring, whether an active voice channel is established in the audio channel. The example method also includes, in the event the active voice channel is not established in the audio channel, calibrating at least one of a noise suppression module of the telephony device and an echo cancellation module of the telephony device.

### TECHNICAL FIELD

This description relates to noise suppression and echo cancellation in telephony devices.

### BACKGROUND

The use of telephony devices is growing at a rapid rate. Such devices may be wired devices, where a cord connects the device to a communication network, or may be wireless devices, where the device communicates with a communication network over an air interface using a radio link. Such a communication network may be a traditional telephone network, a cellular network, or a data network, as some examples. In certain applications, the telephony device may be a headset that is used in conjunction with another telephony device, such as a cellular phone. Such headsets may also be wired or wireless. In such an application, a cellular phone may be used to connect to a cellular communication network using a first wireless link, while the headset may communicate with the cellular phone via a second wireless link or a wired link.

Any number of techniques may be used in order to improve the voice quality for telephony calls conducted using such telephony devices. For instance, two techniques that are used to improve the voice quality of speech communicated using such telephony devices are noise suppression and echo cancellation. For purposes of this disclosure, a person using a telephony device applying such techniques is referred to as a near talker, while a person engaged in a conversation with the near talker is referred to as a far talker. These terms are used for purposes of consistency and clarity. It will be appreciated that other terms or arrangements are possible. For example, such techniques may be applied to both ends of a telephony conversation.

Noise suppression is used to suppress or reduce the amount of ambient noise in a location where the near talker is engaging in a conversation using a telephony device to communicate with a far talker. Echo cancellation is used to cancel (e.g., remove, suppress, or control) the presence of an acoustic echo from a speaker of the telephony device to a microphone of the telephony device. Such an echo may occur, for example, as a result of speech received from the far talker being acoustically coupled from the speaker to the microphone. Both techniques involve training (or calibrating) a respective noise suppression module and echo cancellation module.

Currently, such noise suppression modules and echo cancellation modules are trained while a near talker is engaged in a conversation with a far talker. Because it may take a period of time for the noise suppression module and the echo cancellation module to converge (e.g., learn enough about the environment of the telephony device and the near talker) to effectively suppress noise or cancel echo, initial call quality may be adversely effected by noise and/or echo. Also, training such modules is computationally complex and may consume a significant amount of power. In applications where a device has a limited power supply (e.g., a battery powered device), such training may reduce the amount time a power supply lasts, thus requiring more frequent renewal of the power supply (e.g., recharging or replacing the power supply).

### SUMMARY

According to one general aspect, an example method may include monitoring an audio channel in a telephony device. The example method may also include determining, as a result of the monitoring, whether an active voice channel is established in the audio channel. In the event the active voice channel is not established in the audio channel, the example method may also include calibrating at least one of a noise suppression module of the telephony device and an echo cancellation module of the telephony device.

According to another general aspect, an example telephony device may include a speaker adapted to play first audio information; a microphone adapted to receive second audio information; and an audio channel operationally coupled with the speaker and the microphone. In the example telephony device, the audio channel may be adapted to implement an active voice channel. The audio channel may include a processor and a memory device that is operationally coupled with the processor. In the example device, the memory device may have machine-readable instructions stored thereon that, when executed by the processor, cause the processor to (i) monitor the audio channel; (ii) determine, as a result of the monitoring, whether the active voice channel is established in the audio channel; and (iii) in the event the active voice channel is not established in the audio channel, calibrate at least one of a noise suppression module of the telephony device and an echo cancellation module of the telephony device.

According to another general aspect, an example apparatus may include a machine readable medium having instructions stored thereon. In the example apparatus, the instructions, when executed, may provide for (i) monitoring an audio channel in a telephony device; (ii) determining, as a result of the monitoring, whether an active voice channel is established in the audio channel; and (iii) in the event the active voice channel is not established in the audio channel, calibrating at least one of a noise suppression module of the telephony device and an echo cancellation module of the telephony device.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating an embodiment of a wireless headset that implements noise suppression and echo cancellation.

FIG. 2 is a flowchart illustrating an embodiment of a method for offline calibration of a noise suppression module and/or an echo cancellation module in a telephony device.

FIG. 3 is a flowchart illustrating an embodiment of a method for noise suppression and/or echo cancellation in a telephony device.

FIG. 4 is a flowchart illustrating another embodiment of a method for offline calibration of a noise suppression module and/or an echo cancellation module.

FIG. 5 is a block diagram illustrating an embodiment of a noise suppression module.

FIG. 6 is a flowchart illustrating an embodiment of a method for calibrating a noise suppression module.

FIG. 7 is a block diagram illustrating an embodiment of an echo cancellation module.

FIG. 8 is a flowchart illustrating an example method for calibrating an echo cancellation module.

FIG. 9 is a block diagram illustrating an embodiment of a wireless telephony device.

### DETAILED DESCRIPTION

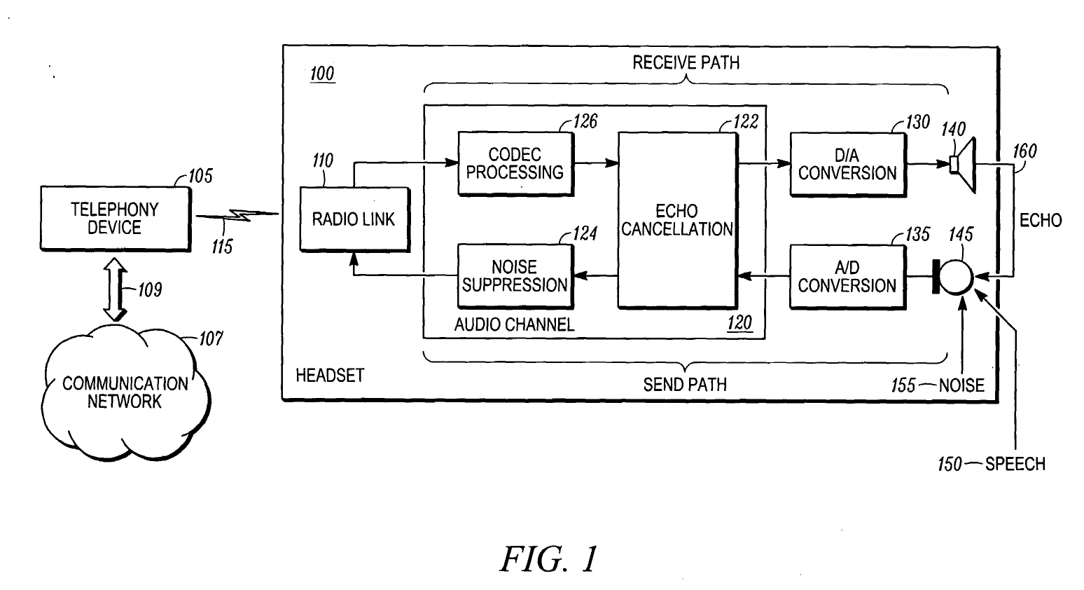

FIG. 1 is a block diagram of an example embodiment of a wireless headset telephony device 100. The headset 100 may operate in conjunction with another telephony device 105 that may take the form of any number of devices, such as a landline phone, a cellular phone, an Internet telephone among any number of other possible telephony devices. For the arrangement shown in FIG. 1, the headset 100 may be operatively coupled with the telephony device 105 using a radio link 110 via an air interface 115. The headset 100 and the telephony device 105 may be communicate over the air interface 115 using any number of wireless protocols, such as the Bluetooth protocol or an 802.11 protocol, as two examples. In other example arrangements, a single telephony device (e.g., a cellular phone) may be used, or a wired headset may be used in conjunction with the telephony device 105.

In the example arrangement illustrated in FIG. 1, the telephony device 105 may also be operably coupled with a communication network 107 via a communication link 109. The communication network 107 may be a conventional telephone network, a cellular telephone network, a local area data network, or a wide area data network, such as the Internet, as some examples. The communication link 109 may be a wired or wireless communication link, depending on the particular embodiment and the structure of the communication network 107. For instance, the communication network 107 may be a cellular telephone network and the communication link 109 may be a wireless link that operates in accordance with the Code Division Multiple Access (CDMA) protocol or the Global System for Mobile Communications (GSM) protocol, for example.

In the headset 100, the radio link 110 may be operationally coupled with an audio channel 120. The radio link 110 may communicate signals received over the air interface 115 from the telephony device 105 to the audio channel 120. Also, the radio link 110 may receive signals from the audio channel 120, which are then communicated to the telephony device 105 over the air interface 115. For purposes of this disclosure, signals being communicated for playback by a headset or other telephony device (erg., from a far talker to a near talker) are referred to as receive path signals, while signal being communicated out of the headset (e.g., from a near talker to a far talker) are referred to as send path signals. A send path and a receive path are indicated in FIG. 1.

The audio channel 120 may be implemented in any number of ways. For instance, the audio channel 120 may be implemented using a combination of hardware, software and/or firmware in any appropriate configuration. The particular arrangement used to implement the audio channel 120 may depend on the embodiment. The audio channel 120 in FIG. 1 may include an echo cancellation module 122, a noise suppression module 124 and a codec processing module 126, for example. These modules may be implemented in an application layer of the headset 100 (or other telephony device). Such an application layer may be implemented using machine executable instructions that are executed by a processor, as is described in further detail below.

In the headset 100, the echo cancellation module 122 may be included in the receive path and the send path. Such an arrangement may allow for the echo cancellation module 122 to compare signals (e.g., voice information) communicated in the send path with signals communicated in the receive path. Further, the echo cancellation module may remove an acoustic echo associated with the receive path signals from the send path signals, as is discussed in further detail below.

As shown in FIG. 1, the noise suppression module 124 of the headset 100 may be included only in the send path. The noise suppression module 124 may be used to suppress noise, such as ambient noise in the environment of a near talker, so as to enhance speech information of the near talker for signals communicated in the send path of the headset 100. Such techniques are also discussed in further detail below.

As is also shown in FIG. 1, the codec processing module 126 may be included only in the receive path of the headset 100. The codec processing module 126 may be used to process audio files, such as MP3 files, or the like. It will be appreciated that the elements of the audio channel 120 are given by way of example. The audio channel 120 may include additional elements in the send path, receive path or both the send and receive paths. Further, the elements of the audio channel 120 may be arranged in other fashions and/or elements may be removed from the audio channel 120. For instance, the codec processing module 126 may be included in both the send path and the receive path.

The receive path of the audio channel 120 may include a digital-to-analog (D/A) converter 130 and the send path may include an analog-to-digital (A/D) converter 145. The D/A converter 130 may be used to convert digital audio information (signals) to analog audio information (signals) for playback by a speaker 140. The speaker 140 may be operationally coupled with the D/A converter 130. Such audio signals may be speech from a far talker, digital music files, prompt sounds from the telephony device 105 (e.g., a ringtone), or any other audio information for playback by the speaker 140.

The A/D converter 135 may be used to convert analog audio information (signals) associated with sound captured by a microphone 145 of the headset 100. In the headset 100, the microphone 145 may be operationally coupled with the A/D converter 135. Such analog audio information may include signals corresponding with speech 150 of a near talker, ambient noise 155 in an environment of the near talker, an acoustic echo 160 from the speaker 140 to the microphone 145, or any number of other sounds.

The headset 100 may be used to implement techniques for echo cancellation and/or noise suppression, such as those described herein. Such techniques may include calibrating the echo cancellation module 122 and the noise suppression module 124. In an example embodiment, the headset 100 may monitor the audio channel 120 to determine whether an active voice channel is established or present in the audio channel 120. An active voice channel may be established in response to a phone call being placed or received using the headset 100 and the telephony device 105 in the example embodiment of FIG. 1. Any number of techniques may be used to monitor the voice channel. For example, when an active voice channel is established, a flag may be set in a processor that is used to implement the audio channel 120. Alternatively, a separate element of an application layer of the headset 100 may query the modules of the audio channel 120 to determine whether an active voice channel is present. Of course, any number of other techniques may be used to make such a determination.

In the example embodiment, the headset 100 may calibrate the echo cancellation module 122 and/or the noise suppression module 124 when an active voice channel is not established in the audio channel 120. Such an approach may be referred to as offline calibration. In such an approach, the echo cancellation module 122 and/or the noise suppression module may be calibrated prior to the headset 100 (or other telephony device) receiving a request to establish an active voice channel in the audio channel 120. Such an approach may provide for improved performance of the echo cancellation module 122 and the noise suppression module 124 at the start of a phone call using the headset 100. Such improved performance at the start of a phone call may result in a better experience for a far talker engaged in a phone call with a near talker using the headset 100.

Also, such offline calibration of the echo cancellation module 122 and/or the noise suppression module 124 may allow for the complexity of calibration for these modules, once an active voice channel is established, to be reduced as compared to more computationally complex techniques. Such an approach may reduce the amount of power that is consumed by the headset 100. Accordingly, such an approach may increase the life of a limited power supply (e.g., a rechargeable or replaceable battery) used to operate the headset 100, thus reducing the frequency at which the power supply must be renewed (e.g., recharged or replaced).

The headset 100 may process audio information (signals) in the headset 100 based on such an offline calibration. In such an approach, the headset 100 may receive a request to establish an active voice channel in the audio channel 120. Such a request may result from a user (e.g., near talker) of the headset 100 placing an outgoing call using the telephony device 105 or the headset 100. Alternatively, for example, a request to establish an active voice channel in the audio channel 120 make result from a user indicating acceptance of an incoming call (e.g., from a far talker). The user of the headset 100 may indicate acceptance of the incoming call using the telephony device 105 or the headset 100. Other techniques for indicating acceptance of an incoming call may also be used. For instance, the telephony device 105 and/or the headset 100 may be configured to automatically answer incoming calls after a certain period of time or number of rings.

Once the active voice channel is established in the audio channel 120, the headset 100 may receive, via the microphone 145, the speech 150 from the near talker. The microphone 145 may also receive the noise 155 from the surrounding environment of the near talker and the echo 160 that may result from acoustic coupling between the speaker 140 and the microphone 145. The noise 155, for instance, may be the hum of an engine if the near talker is engaged in a telephone call while driving a vehicle. Alternatively, the noise may be due to any number of sources in the vicinity of the near talker.

In this example, the A/D converter 135 may convert the speech 150, the noise 155 and the echo 160 to digital information (signals) and provide the digital information associated with the speech 150, the noise 155 and the echo 160 to the audio channel 120 (i.e., the echo cancellation module 122). In this example, the radio link 110, the audio channel 120, the D/A converter 130 and the A/D converter 145 may be used to implement the active voice channel in the headset 100. This arrangement is given by way of example and any number of other arrangements is possible.

The echo cancellation module 122 may receive the digital audio information from the A/D converter 135 and then process that digital audio information to substantially cancel the echo 160 from the digital information. This processing of the digital information received from the A/D converter 135 may be based on the offline calibration of the echo calibration module 122. After processing the digital audio information to substantially cancel the echo 160, the echo cancellation module 122 may provide the processed digital information to the noise suppression module 124 for further processing.

The noise suppression module 124 may receive the processed digital information from the echo cancellation module 122 and further process the received digital information to suppress the noise 155 and enhance the speech 150 in the digital information. This further processing of the digital information may be based on the offline calibration of the noise suppression module 124, such as described above. After this further processing, the noise suppression module 124 may provide the further processed digital information to the radio link 110 for communication to the telephony device 105 via the air interface 115.

Other arrangements may be implemented in the headset 100. For instance, the noise suppression module 124 may process the digital audio information prior to the processing of the digital audio information by the echo cancellation module 122. As another alternative, the processing operations of the echo cancellation module 122 and the noise suppression module 124 may be implemented in a single module. As yet other alternatives, the headset may implement the noise suppression module 124 but not the echo cancellation module 122 and vice versa.

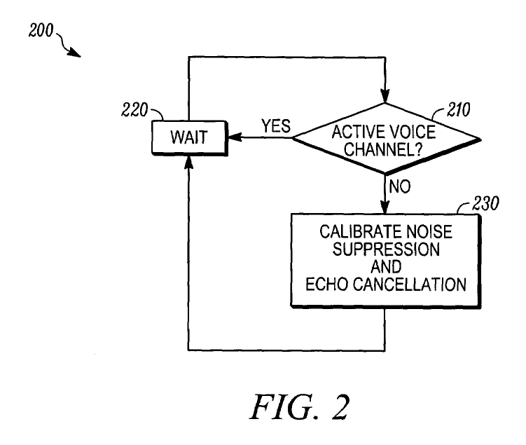

FIG. 2 is a flowchart illustrating a method 200 for offline calibration of a noise suppression module and an echo cancellation module in a telephony device. The method 200 may be implemented in the headset 100 of FIG. 1. Alternatively, the method 200 may implemented in any number of other telephony devices such as cellular phones, landline phones, corded headsets and Internet Protocol phones, as some examples.

The method 200, at block 210, includes determining whether an active voice channel is present in a telephony device, such as the headset 100. If it is determined than an active voice channel is present in the telephony device, the method 200 may proceed to block 220, where the telephony device may wait some period of time, and then return to decision block 210 to determine if an active voice channel is present in an audio channel of the telephony device. The period of time used at block 220 depends on the particular embodiment. The period of time may be determined by the telephony device based on prior offline calibration operations, or may be predetermined by a manufacturer of the telephony device. As another alternative, a user of the telephony device may determine the period of time used at block 220.

In the method 200, if it is determined at block 210 that an active voice channel is not present in the telephony device, the method 200 may proceed to block 220. At block 220, the method 220 may include calibrating a noise suppression module and/or an echo cancellation module offline, as described above with respect to FIG. 1. After the offline calibration at block 220, the method 200 may proceed to block 230, and the telephony device may wait a period of time before proceeding again to decision block 210. Such an arrangement allows for periodic offline calibration of the telephony device.

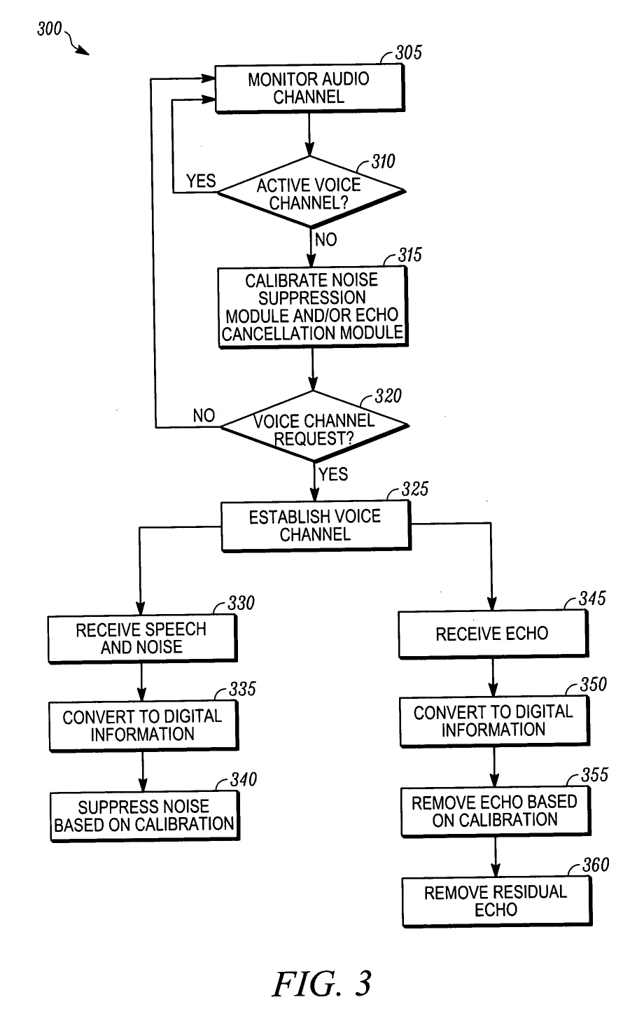

FIG. 3 is a flowchart illustrating an embodiment of an example method 300 for noise suppression and echo cancellation in a telephony device. The method 300 will be described with further reference to the headset 100 of FIG. 1. It will be appreciated, however, that the method 300 may be implemented using any number of telephony devices.

The method 300, at block 305, may include monitoring the audio channel 120. As discussed above, such monitoring may be accomplished in any number of ways, such as using processor flags or querying an application layer of the headset 100. Alternatively, the monitoring at block 305 may include waiting a period of time before proceeding to the next operation in the method 300, such as was discussed above with respect to the method 200 shown in FIG. 2.

Based on the monitoring at block 305, the method 300 may include, at block 310, determining whether an active voice channel is present in the audio channel 120. If an active voice channel is present, the method 300 may return to block 305 and the headset 100 may continue to monitor the audio channel 120. If an active voice channel is not present in the audio channel 120, the method 300 may proceed to block 315 where offline calibration of the echo cancellation module 122 and/or the noise suppression module 124 may occur. After offline calibration at block 315, the method 300 may proceed to block 320 where a determination is made whether a request to establish an active voice channel has been received by the headset 100. If such a request has not been received, the method 300 may return to block 305 and the headset may return to monitoring the audio channel 120.

If it is determined at block 320 that a request to establish an active voice channel has been received by the headset 100, the method 300 may then proceed to block 325 and the headset 100 may establish the requested active voice channel in the audio channel 120.

As shown in FIG. 3, the method 300 may proceed from block 325 along two parallel paths. For one path, the method 300 may proceed to block 330 where the microphone 145 of the headset 100 may receive the speech 150 from a near talker and the noise 155 from the surroundings of the near talker. The method 300 may then proceed to block 335 where the A/D converter 135 may convert the speech 150 and the noise 155 to digital audio information. The method 300 may then proceed to block 340 where the noise suppression module may suppress the noise and enhance the speech in the digital audio information based on the offline calibration of the noise suppression module at block 315.

For the other path, the method 300 may proceed from block 325 to block 345, where the acoustic echo 160 from the speaker 140 may be received at the microphone 145. Depending on the situation, the echo 160 may be received by the microphone 145 along with the speech 150 and the noise 155. At block 350, the A/D converter 135 may convert the echo 160 to digital audio information. If the speech 155 and the noise 160 are received along with the echo 160, they may also be converted to digital audio information at block 350.

At block 355, the method 300 includes removing at least a portion of the echo 160 using the echo cancellation module 122. The echo cancellation module 122 may remove the echo 160 based on signals received by the receive path of the headset 100 and an echo path model based on the offline calibration of the echo cancellation module 122 at block 315. At block 360, the method 300 may include removing a residual echo from the digital audio information. Such a residual echo may result from non-linearities in the headset 100 or inaccuracies in an echo path model.

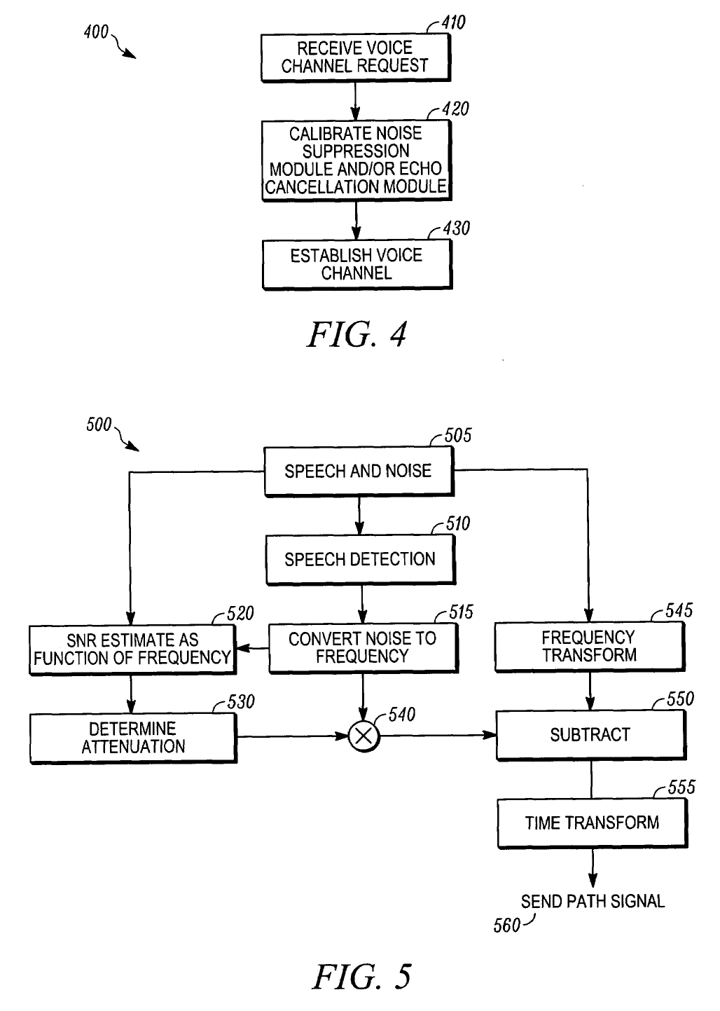

FIG. 4 is a flowchart illustrating another example method for offline calibration of a noise suppression module and/or an echo cancellation module. The method 400, at block 410, includes receiving a voice channel request at a telephony device at a first point in time. As previously discussed, such a request may occur due to an outgoing call being placed or due to an incoming call being accepted. The method 400 further includes, at block 420, calibrating a noise suppression module 124 and/or an echo cancellation module 122 in response to the request to establish the active voice channel.

At block 430, the method 400 includes establishing the voice channel in response to the request received at block 410 at a second point in time, where the second point in time is subsequent to the first point in time. Depending on the particular embodiment, establishing the voice channel at block 430 may be delayed for a period of time after the request is received at block 410 to provide time for performing offline calibration of the noise suppression module and/or echo cancellation module at block 420. In this situation, offline calibration of the echo cancellation module and the noise suppression module may be performed between the first point in time and the second point in time. Such a delay may be on the order of milliseconds, for example. In other embodiments, such a delay may occur intrinsically between the time the request is made at block 410 and the time the voice channel is established at block 430.

FIG. 5 is a block diagram illustrating a noise suppression module 500. The noise suppression module 500 may be implemented in the headset 100 of FIG. 1 as the noise suppression module 124, for example. The noise suppression module 500 may receive speech and noise audio information 505 that may include audio information corresponding with near talker speech and noise from the surroundings of the near talker. The speech and noise 505 may be in the form of digital audio information that is provided by an A/D converter, as previously described.

The speech and noise 505 may be provided to a speech detection module 510. The speech detection module 510 may analyze the speech and noise 505 to make a determination as to what components of the speech and noise 505 are near talker speech and which components are noise from the near talker's surroundings. The speech detection module 510 may then provide these determinations to a frequency conversion module 515. The frequency conversion module 515 may transform the noise component, as determined by the speech detection module 510, from the time domain to the frequency domain (e.g., using a Fourier transform). The frequency converted noise component may then be provided to a signal-to-noise (SNR) estimator 520 by the frequency conversion module 515. The speech and noise 505 may also be provided to the SNR estimator 520.

The SNR estimator 520 may compare the frequency converted noise component to the speech and noise 505 to estimate a signal-to-noise ratio for the speech and noise 505 (i.e. a ratio of power in the near talker speech spectrum to the power in the noise spectrum from the near talker's surroundings) at a particular frequency or averaged over a range of frequencies. The SNR estimate may be a full-band estimate (e.g., audible frequencies) or may be separated into sub-bands.

The SNR estimator 520 may provide the SNR estimate or estimates to an attenuation determination module 530. The attenuation determination module 530 may then determine an amount of attenuation to be applied to the signal and noise 505 based on the SNR estimate(s). As with the SNR estimate(s) made by the SNR estimator 520, the amount of attenuation may be determined on a full-spectrum basis or may be determined by frequency sub-band. By way of example, the amount of attenuation to be applied to the speech and noise 505 may be determined using a look-up-table using the SNR estimate(s) as lookup values.

The frequency converted noise received from frequency converter 515 may be combined with the attenuation determinations from the attenuation determination module 530 at a combiner 540. The speech and noise 505 are transformed from the time domain to the frequency domain using a frequency transform block 545 that may apply, for example, a Fourier transform to the time domain signal to generate the frequency domain signal. The determined attenuation for the frequency converted noise is applied (e.g., full-spectrum or by sub-band) at a subtractor 550. Applying such attenuation may result in suppressing the noise and, thus, enhancing the near talker's speech. Accordingly, the subtractor 550 may produce speech-enhanced frequency-domain audio information, which may then be converted to speech-enhanced time-domain audio information by a time transformation module 555. The time transformation module 555 may then provide the time-domain audio information to other elements of the telephony device (such as an echo canceller or radio link) as a send path signal 560.

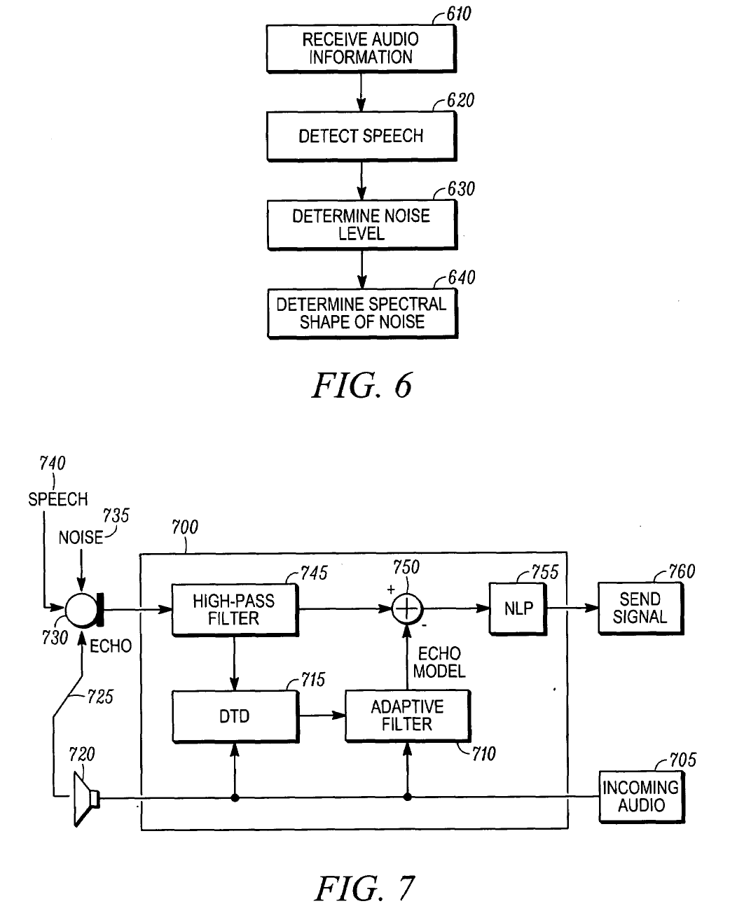

FIG. 6 is a flowchart illustrating a method 600 for offline calibration of the noise suppression module 500 shown in FIG. 5. The method 600 includes, at block 610, receiving audio information at a microphone of a headset. This audio information may be near talker speech and noise from a near talker's surroundings. Depending on the embodiment, the received audio information may be converted to digital audio information, such as the noise and speech 505 in FIG. 5. The method 600, at block 620, includes detecting near talker speech in the speech and noise 505 and also includes, at block 630, determining a noise level in the speech and noise 505. The method 600 further includes, at block 640, determining a frequency spectrum of the noise. For the method 600, the speech detection module 510 and the frequency conversion module 515 of the noise suppression module 500 may perform the operations of blocks 620, 630 and 640. By performing such calibration of the noise suppression module 500 “offline” (i.e., prior to establishing an active voice channel), initial voice quality may be improved once an active voice channel is established.

FIG. 7 is a block diagram illustrating an example embodiment of an echo cancellation module 700. The echo cancellation module 700 may receive incoming audio information 705, which may be, for example, digital audio information corresponding with speech of a far talker. Alternatively, such as during offline calibration, the incoming audio 705 may be a digital audio file, such as a .wav file or an MP3 file, for example.

When performing echo cancellation during a phone call, the incoming audio 705 (e.g. far talker speech) may be provided to an adaptive filter 710 and a double-talk detector (DTD) 715 as a reference signal. The audio information 705 may also be provided to a speaker 720 (e.g., after D/A conversion) for playback to a near talker. Playing back the audio information 705 maybe produce an acoustic echo 725, which may be captured by a microphone 730 along with noise 735 and/or near talker speech 740. The captured audio (the echo 725, along with any noise 735 or speech 740) may be provided to a high-pass filter 745. The high-pass filter 745 may remove any low-frequency components from the captured audio and provide filtered, captured audio to the DTD 715. In similar fashion as the noise suppression module 500, various elements of the echo cancellation module 700 (e.g., the adaptive filter 710, the DTD 715 and the NLP 755) may operate on full spectrum signal or may operate on frequency sub-band signals.

The DTD 715 may compare the filtered, captured audio, accounting for delay of the echo, with the reference signal. Based on this comparison, the DTD 715 may determine whether there is any near talker speech in the captured audio. If the DTD 715 determines that there is near talker speech in the captured audio, the DTD 715 may instruct the adaptive filter 710 not to adapt an echo path model based on a comparison of the captured audio with the reference signal. In such a situation, the adaptive filter 710 may still compare the captured audio with the reference signal using a current echo path model to identify the echo 725 in the captured audio. The adaptive filter 710 may provide a frequency-domain representation of the identified echo to a subtractor 750, which may subtract the identified echo from the captured audio (e.g., using the frequency domain representation of the identified echo and a frequency-domain representation of the captured audio). The subtractor 750 may supply the captured audio, after cancelling the echo, to a non-linear processor (NLP) 755. The NLP 755 may be used to cancel residual echo in the captured audio. As discussed above, such a residual echo may result due to non-linearities of the components in a telephony device and/or due to errors in the echo path model. The echo cancellation module 700 may then produce a send signal 760, for example, by converting the captured audio (after echo cancellation) from the frequency domain to the time domain. The send signal 760 may then be provided to other components of a telephony device, such as a radio link or a noise suppression module, as two examples.

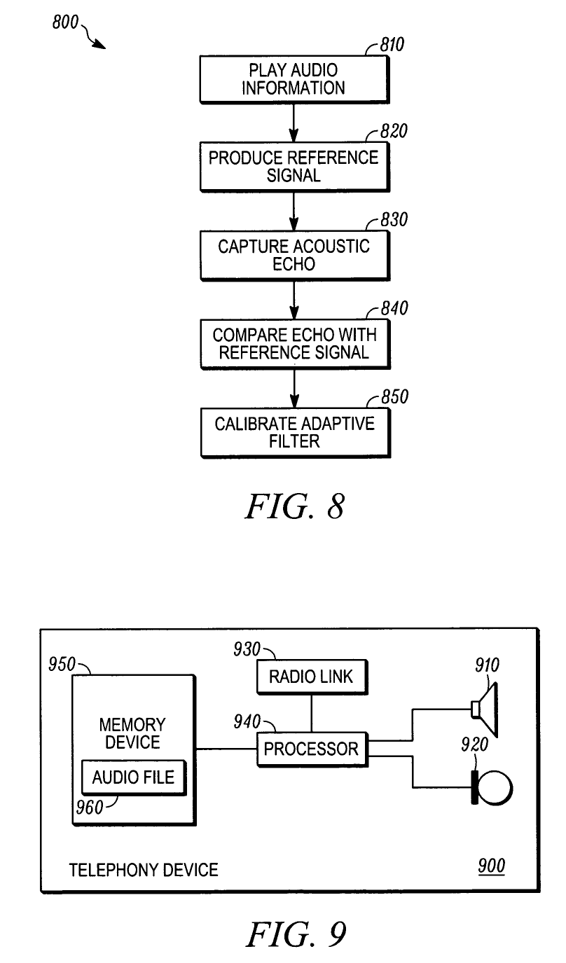

FIG. 8 is a flowchart illustrating an example method 800 for calibrating the echo cancellation module 700. The method 800 includes, at block 810, playing audio information. Such audio information may be a digital music file, a training signal adapted for echo cancellation training, or any other appropriate audio information. At block 820, a reference signal is produced from the audio information. At block 830 an acoustic echo associated with the played audio information is captured at microphone of a telephony device in which the echo cancellation module 700 is included. At block 840, the captured echo is compared with the reference signal and, at block 850, an echo path model included in an adaptive filter is updated based on the comparison.

If such calibration is performed in an offline mode (e.g., while an active voice channel is not established) there generally would not be any near talker speech. However, the method 800 may also include double-talk detection to prevent the echo path model from being adapted based on captured audio that includes near talker speech. Adapting the echo path model in such a situation may be undesirable as a highly inaccurate echo path model may result. As with offline calibration of the noise suppression model 500, offline calibration of the echo cancellation module 700 using the method 800 may improve initial voice quality for telephone calls established after such offline calibration.

FIG. 9 is a block diagram of a telephony device 900 that may be used to implement the noise suppression and echo cancellation techniques described herein. The telephony device 900 includes a speaker 910 and microphone 920 for, respectively playing and capturing audio information. The speaker 910 and microphone 920 are operationally coupled with a processor 940, which may take the form of a microprocessor or digital signal processor, as two examples. The processor 940 may include A/D converters, D/A converters and other elements described above. For instance, the processor 940 may be used to implement an audio channel including an application layer with an echo cancellation module and a noise suppression module.

The processor 940 may be further operationally coupled with a radio link 930 and a memory device 950. The radio link 930 may be used to operationally couple the telephony device with a communication network or with another telephony device, as was previously described. The memory device 950 may include machine readable instructions that may be used by the processor 940 to implement the application layer and/or audio channel of the telephony device 900. The memory device 950 may further include an audio file 960 that may be used for offline calibration of an echo cancellation module, as was previously discussed.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data-include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
monitoring an audio channel in a telephony device;
determining, as a result of the monitoring, whether an active voice channel is established in the audio channel; and
in the event the active voice channel is not established in the audio channel, calibrating at least one of a noise suppression module of the telephony device and an echo cancellation module of the telephony device.

2. The method of claim 1, wherein the monitoring of the audio channel comprises:
monitoring an application layer of the telephony device, wherein the application layer is adapted to implement the active voice channel, the noise suppression module and the echo cancellation module.

3. The method of claim 1, wherein determining whether the active voice channel is established in the audio channel comprises:
determining, at a first point in time, that the telephony device has received a request to establish the active voice channel; and
determining, at a second point in time, that the active voice channel has been established in the audio channel in response to the request,
wherein the calibrating of the at least one of the noise suppression module and the echo cancellation module occurs during a time period between the first point in time and the second point in time.

4. The method of claim 1, further comprising:
establishing the active voice channel in the audio channel;
receiving speech from a user of the telephony device at a microphone of the telephony device;
receiving noise at the microphone;
converting the speech and the noise to digital information in the active voice channel; and
processing the digital information with the noise suppression module to suppress the noise so as to enhance the speech in the digital information, wherein the processing is based on the calibrating of the noise suppression module.

5. The method of claim 1, further comprising:
establishing the active voice channel in the audio channel;
receiving an acoustic echo from a speaker of the telephony device at a microphone of the telephony device;
converting the acoustic echo to digital information in the active voice channel; and
processing the digital information with the echo cancellation module to cancel at least a portion of the echo in the digital information, wherein the processing is based on the calibrating of the echo cancellation module.

6. The method of claim 5, further comprising removing a residual echo from the digital information using a non-linear processor.

7. The method of claim 1, wherein the calibrating of the echo cancellation module comprises:
playing audio information with a speaker of the telephony device;
producing a reference signal from the audio information;
capturing an acoustic echo associated with the played audio information with a microphone of the telephony device;
comparing the captured acoustic echo with the reference signal; and
calibrating an adaptive filter of the echo cancellation module based on the comparing of the captured acoustic echo and the reference signal.

8. The method of claim 7, wherein the audio information comprises one of a user selected audio file and a probe signal.

9. The method of claim 1, wherein the calibrating of the at least one of the noise suppression module and the echo cancellation module is performed at periodic intervals.

10. The method of claim 1, wherein the calibrating of the noise suppression module comprises:
receiving audio information at a microphone of the telephony device;
determining a level of noise in the audio information; and
determining a frequency spectrum of the noise.

11. A telephony device comprising:
a speaker adapted to play first audio information;
a microphone adapted to receive second audio information; and
an audio channel operationally coupled with the speaker and the microphone,
wherein the audio channel is adapted to implement an active voice channel in the telephony device, the audio channel comprising:
a processor; and
a memory device operationally coupled with the processor, the memory device having machine-readable instructions stored thereon that, when executed by the processor, cause the processor to:
monitor the audio channel;
determine, as a result of the monitoring, whether the active voice channel is established in the audio channel; and
in the event the active voice channel is not established in the audio channel, calibrate at least one of a noise suppression module of the telephony device and an echo cancellation module of the telephony device.

12. The telephony device of claim 11, wherein the noise suppression module and the echo cancellation module are implemented in an application layer of the telephony device, the application layer being implemented, at least in part, by the processor.

13. The telephony device of claim 11, wherein determining whether the active voice channel is established in the audio channel comprises:
determining that the telephony device has received a request to establish the active voice channel at a first point in time; and
determining that the active voice channel has been established in the audio channel at a second point in time in response to the request,
wherein the calibrating of the at least one of the noise suppression module and the echo cancellation module occurs during a time period between the first point in time and the second point in time.

14. The telephony device of claim 11, wherein the calibrating of the echo cancellation module comprises:
playing the first audio information with the speaker;
producing a reference signal from the first audio information;
capturing the second audio information with the microphone, wherein the second audio information includes an acoustic echo associated with the played first audio information;
comparing the second audio information with the reference signal; and
calibrating an adaptive filter of the echo cancellation module based on the comparing of the second audio information and the reference signal.

15. The telephony device of claim 14, wherein the first audio information comprises a digital music file.

16. The telephony device of claim 11, wherein the calibrating of the at least one of the noise suppression module and the echo cancellation module occurs at periodic intervals.

17. The telephony device of claim 11, wherein calibrating the noise suppression module comprises:
receiving the second audio information at the microphone;
determining a level of noise in the second audio information; and
determining a frequency spectrum of the noise.

18. An apparatus comprising:
a machine readable medium having instructions stored thereon, wherein the instructions, when executed, provide for:
monitoring an audio channel in a telephony device;
determining, as a result of the monitoring, whether an active voice channel is established in the audio channel; and
in the event the active voice channel is not established in the audio channel, calibrating at least one of a noise suppression module of the telephony device and an echo cancellation module of the telephony device.

19. The apparatus of claim 18, wherein determining whether the active voice channel is established in the audio channel comprises:
determining that the telephony device has received a request to establish the active voice channel at a first point in time; and
determining that the active voice channel has been established in the audio channel at a second point in time in response to the request,
wherein the calibrating of the at least one of the noise suppression module and the echo cancellation module occurs during a time period between the first point in time and the second point in time.

20. The apparatus of claim 18, wherein the calibrating of the at least one of the noise suppression module and the echo cancellation module occurs at periodic intervals.
